(19) United States
(12) Patent Application Publication
(10) Pub. No.: US 2025/0333863 A1
(43) Pub. Date: Oct. 30, 2025

(54) SQUARE-METER-SCALE STAINLESS STEEL INTEGRATED ELECTRODE WITH SURFACE MODIFIED BY BIMETALLIC SULFIDE AND PREPARATION METHOD AND APPLICATION THEREOF

(71) Applicant: HAINAN UNIVERSITY, Hainan (CN)

(72) Inventors: Yida DENG, Hainan (CN); Yang WANG, Hainan (CN); Rouna JIA, Hainan (CN); Feiyu LI, Hainan (CN); Zeqi HE, Hainan (CN); Xuerong ZHENG, Hainan (CN); Zhong HUANG, Hainan (CN); Haozhi WANG, Hainan (CN)

(73) Assignee: HAINAN UNIVERSITY, Hainan (CN)

(21) Appl. No.: 19/062,045

(22) Filed: Feb. 25, 2025

(30) Foreign Application Priority Data
Apr. 30, 2024 (CN) 202410533648.9

(51) Int. Cl. C25B 11/046; C25B 1/04

(52) U.S. Cl. CPC C25B 11/046; C25B 1/04

(57) ABSTRACT

Disclosed in the present disclosure are a square-meter-scale stainless steel integrated electrode with a surface modified by bimetallic sulfide, and a preparation method and application thereof. The preparation method includes the following steps: (1) performing ultrasonic cleaning on a stainless steel substrate with deionized water, acetone and ethanol in sequence, performing heating and soaking with a dilute hydrochloric acid solution, and finally, performing drying after washing and cleaning with deionized water to obtain the stainless steel substrate with a clean surface; (2) dissolving two transition metal cation salts and a sulfur source in an aqueous solution and performing stirring at a room temperature for even mixing; and (3) putting the stainless steel substrate with the clean surface obtained in step (1) into the solution of the step (2) for a heating reaction, washing an obtained sample with water after the reaction is finished, and then, performing drying.

### CROSS REFERENCE TO RELATED APPLICATIONS

This application claims the priority benefit of China application serial no. 202410533648.9, filed on Apr. 30, 2024. The entirety of the above-mentioned patent application is hereby incorporated by reference herein and made a part of this specification.

### TECHNICAL FIELD

The present disclosure belongs to the technical field of water electrolysis for hydrogen production, and particularly relates to a square-meter-scale stainless steel surface-modified integrated electrode formed through transition metal sulfurization, and an application thereof in water electrolysis. A preparation method for an electrode is provided, which has a simple process and a low cost and is applicable to industrial water electrolysis for hydrogen production.

### BACKGROUND

With the transformation of China's economy from a high-speed growth model to a high-quality development model, it is urgent to build a clean, low-carbon, safe and efficient energy system. Since hydrogen has a very high energy density (283 kJ mol⁻¹) and its only product of combustion is water, the hydrogen is a type of ideal, efficient and clean renewable energy. The water electrolysis technology for hydrogen production can store electric energy generated by renewable clean energy such as solar energy, wind energy and tidal energy as hydrogen energy, thus realizing the cleanliness and low carbonization of a hydrogen energy industry in the whole life cycle. The water electrolysis technology plays a key role in the cleanliness and low carbonization of the whole hydrogen energy industry. The water splitting process is divided into cathodic hydrogen evolution reaction (HER) and anodic oxygen evolution reaction (OER). Both the HER and OER electrochemical processes occur at the gas-solid-liquid three-phase interface, involving the diffusion, adsorption and activation of reactants, formation and transformation of reaction intermediates, desorption of products, and charge transfer. The reaction kinetics of these steps are sluggish and the reaction barrier is too high, which seriously limits the hydrogen production efficiency through water electrolysis and a service life. At present, the most ideal catalysts for HER and OER are noble metal Pt-based and RuO₂/IrO₂-based materials. However, large-scale application of noble metal electrocatalysts is greatly hindered due to the defects of scarcity, high cost and continuous poor stability during operation process, Therefore, it is urgent to develop a low-cost, efficient and steady non-noble metal based electrocatalyst, so as to reduce the reaction energy barrier and accelerate the kinetic characteristics of the interface reaction. The electrocatalyst is crucial to improving the efficiency of hydrogen production through water electrolysis and reducing the cost of hydrogen production, and its development is a key scientific problem to be solved urgently.

At present, among many non-noble metal based water electrolysis catalytic materials, transition metal sulfides are considered to be one of the most potential catalysts for replacing noble metal catalysts in water electrolysis field due to abundant reserves, low price, adjustable morphology and composition, diverse crystal structure and good stability. In addition, since an electrochemical hydrogen evolution process is a reaction involving a liquid-solid-gas three-phase interface, a catalytic electrode should not only have good catalytic activity, but also have good conductivity and a three-dimensional porous structure to improve a mass transfer process of reactants and products and a gas diffusion process. This characteristic is especially important under high current conditions, and it is necessary to optimize and treat the overall structure and surface of the catalytic electrode. Finally, existing hydrogen production through water electrolysis is mainly carried out in alkaline electrolyte, but strong alkaline solutions are highly corrosive to the electrolytic cell and the catalysts, and powder catalysts are often dissolved and peeled off during the reaction process, resulting in attenuation of the activity of the powder catalysts. Therefore, an integrated electrode with low cost, excellent efficiency, simple preparation process and square-meter-scale preparation is urgently needed to satisfy the demand of industrial large-scale water electrolysis for hydrogen production.

### SUMMARY

In order to solve the problems existing in the above technology, the present disclosure provides a preparation method for a square-meter-scale stainless steel integrated electrode with a surface modified by bimetallic sulfide for water electrolysis for hydrogen production. The present disclosure has the advantages that a low cost and a simple process are realized, the prepared integrated electrode has excellent catalytic activity and stability, square-meter-scale preparation can be achieved, and the method is applicable to large-scale industrial alkaline water electrolysis for hydrogen production.

The specific technical solutions of the present disclosure are as follows:

A square-meter-scale stainless steel integrated electrode with a surface modified by bimetallic sulfide has a structure of a nanosphere wrapped in an ultrathin nanosheet, the ultrathin nanosheet is made from nickel sulfide, the nanosphere is made from elemental sulfur, and materials of elemental sulfur nanospheres wrapped in ultrathin nickel sulfide nanosheets are uniformly distributed on a surface of stainless steel.

Further, the ultrathin nanosheet has a thickness of 5-50 nm, and the nanosphere has a diameter of 5-50 um.

Further, the square-meter-scale stainless steel integrated electrode with a surface modified by bimetallic sulfide is prepared by a one-step hydrothermal method.

A preparation method for the square-meter-scale stainless steel integrated electrode with a surface modified by bimetallic sulfide includes the following steps:
(1) performing ultrasonic cleaning on a stainless-steel substrate with deionized water, acetone and ethanol in sequence, and then heating and soaking with a dilute hydrochloric acid solution, and finally, performing drying after washing and cleaning with deionized water to obtain the stainless-steel substrate with a clean surface;
(2) dissolving two transition metal cation salts and a sulfur source in an aqueous solution and performing stirring at a room temperature for even mixing;
(3) putting the stainless-steel substrate with the clean surface obtained in step (1) into the solution of the step (2) for a heating reaction, washing an obtained sample with water after the reaction is finished, and then, performing drying to obtain the square-meter-scale stainless steel integrated electrode with a surface modified by bimetallic sulfide.

Further, in step (1), the time of the ultrasonic cleaning is 5-20 min, a concentration of diluted hydrochloric acid is 1-5 mol L⁻¹, an acid soaking temperature is 50-80° C., and acid soaking time is 1-8 h.

Further, in step (2), the transition metal cation salts are at least one of nitrate, sulfate, chloride, carbonate or acetate of transition metal cations, the metal cations are at least two of titanium, vanadium, chromium, manganese, iron, cobalt, nickel, copper, zinc or molybdenum, and the sulfur source is at least one of thiourea, thioacetamide, sodium sulfide, thiophenol, thiol and thioether. In the solution, a molar ratio of sulfur anions to the transition metal cations is 1:5-5:1, and a molar ratio of the two transition metal cations is 1:4-4:1.

Further, in step (2), time for stirring at a room temperature is 30-120 min.

Further, in step (3), a reaction temperature is 60-100° C., reaction time is 12-24 h, drying temperature is 30-100° C., and drying time is 1-6 h.

An application of the square-meter-scale stainless steel integrated electrode with a surface modified by bimetallic sulfide as an integrated electrode material in an electrocatalytic reaction.

Further, the electrocatalytic reaction is a water electrolysis hydrogen evolution reaction.

Compared with the prior art, the present disclosure has the following advantages:
1. According to the square-meter-scale stainless steel integrated electrode with a surface modified by bimetallic sulfide, the transition metal and the sulfur source are sulfurized directly on the stainless-steel surface, and the formed integrated electrode has good electrochemical activity and stability, and a sulfide on the stainless steel surface is less likely to peel off, such that long service life is realized.
2. According to the square-meter-scale stainless steel integrated electrode with a surface modified by bimetallic sulfide prepared in the present disclosure, the ratio of the metal cations and sulfur anions can be flexibly adjusted, the type and ratio of the two metal cations can also be adjusted, an application range is wide, conditions are easy to control, and operation is simple.
3. According to the preparation method provided by the present disclosure, the stainless-steel serves as the substrate, such that the cost is low, and the process is simple. Reaction conditions are easy to control, square-meter-scale preparation can be achieved, and the method is applicable to large-scale industrial alkaline water electrolysis for hydrogen production.
4. The square-meter-scale stainless steel integrated electrode with a surface modified by bimetallic sulfide prepared in the present disclosure exhibits excellent catalytic performance in an electrocatalytic water decomposition oxygen evolution system, and the electrode has broad prospects in industrialization of water electrolysis for hydrogen production owing to these advantages.

### BRIEF DESCRIPTION OF THE DRAWINGS

In order to more clearly describe the technical solutions in the examples of the present disclosure or in the prior art, a brief introduction to the accompanying drawings required for the description of the examples or the prior art will be provided below. Obviously, the accompanying drawings in the following description are merely some examples of the present disclosure. Those of ordinary skills in art can also derive other accompanying drawings from these accompanying drawings without making inventive efforts.

FIG. 1 shows scanning electron microscopy (SEM) images of a square-meter-scale stainless steel integrated electrode under different scales in Example 1.

FIG. 2 shows transmission electron microscopy (TEM) and energy-dispersive X-ray spectroscopy elemental analysis of a square-meter-scale stainless steel integrated electrode in Example 1.

FIG. 3 is a high-resolution transmission electron microscopy (HRTEM) image of a square-meter-scale stainless steel surface-modified integrated electrode in Example 1.

FIG. 4 shows X-ray diffraction (XRD) patterns of a square-meter-scale stainless steel integrated electrode in Example 1.

FIG. 5 shows a large-area preparation image of a square-meter-scale stainless steel integrated electrode in Example 1.

FIG. 6 shows the square-meter-scale stainless steel integrated electrode as an anode for anion exchange membrane water electrolysis in Example 1.

FIG. 7 shows a performance diagram of Examples 1, 2 and 3 in an electrocatalytic water decomposition oxygen evolution reaction.

FIG. 8 shows a performance diagram of Examples 1, 4 and 5 in an electrocatalytic water decomposition oxygen evolution reaction.

FIG. 9 shows a stability constant current diagram of Example 1 in an electrocatalytic water decomposition oxygen evolution reaction.

### DETAILED DESCRIPTIONS OF THE EMBODIMENTS

A preparation process of the present disclosure is described in detail below through the examples, but the scope of protection claimed in the present disclosure is not limited by the following examples.

A square-meter-scale stainless steel integrated electrode with a surface modified by bimetallic sulfide provided by the present disclosure has a structure of a nanosphere wrapped in an ultrathin nanosheet, the ultrathin nanosheet is nickel sulfide, the nanosphere is elemental sulfur, and materials of elemental sulfur nanospheres wrapped in ultrathin nickel sulfide nanosheets are uniformly distributed on a surface of stainless steel.

The nanosheet has a thickness of 5-50 nm and the composition of nickel sulfide.

The nanosphere has a diameter of 5-50 nm and the composition of elemental sulfur.

The square-meter-scale stainless steel integrated electrode with a surface modified by bimetallic sulfide is prepared by a one-step hydrothermal method.

A preparation method for the square-meter-scale stainless steel integrated electrode with a surface modified by bimetallic sulfide of the present disclosure includes the following specific preparation steps:
(1) A stainless-steel substrate is cleaned ultrasonically with deionized water, acetone and ethanol in sequence for 5-20 min.
(2) The ultrasonically cleaned stainless steel substrate in step (1) is heated and soaked in a diluted hydrochloric acid solution, where a concentration of diluted hydrochloric acid is 1-5 mol L⁻¹, acid soaking time is 1-8 h, an acid soaking temperature is 50-80° C., and the acid soaking time is preferably 2-6 h.
(3) The stainless-steel substrate subjected to acid soaking in step (2) is washed and cleaned with deionized water, and then dried to obtain the stainless-steel substrate with a clean surface.
(4) Two transition metal cation salts and a sulfur source are dissolved in an aqueous solution. The transition metal cation salts are preferably nitrate of transition metal cations, the transition metal cations are preferably iron and nickel, and the sulfur source is preferably thiourea.

In the solution, a molar ratio of sulfur anions to the transition metal cations is 1:5-5:1, and a molar ratio of the two transition metal cations is 1:4-4:1.
(5) The solution prepared in step (4) is stirred at a room temperature for 30-120 min to be evenly mixed, and stirring time is preferably 50-100 min.
(6) Then, the stainless-steel substrate with the clean surface obtained in step (3) is put into the solution of the step (5) after stirring for a heating reaction, where a reaction temperature is 60-100° C., and reaction time is 12-24 h.
(7) An obtained sample after the reaction is finished in step (6) is washed with water, and then dried for 1-6 h at 30-100° C. to obtain the square-meter-scale stainless steel integrated electrode with a surface modified by bimetallic sulfide.

The products of Examples 1˜4 of the present disclosure were tested by the following instruments and methods:

The morphology of the product of Example 1 was characterized by scanning electron microscopy (SEM).

The morphology and element distribution of the product of Example 1 were characterized by using transmission electron microscopy (TEM).

Structural information of Example 1 was analyzed through an X-ray diffraction (XRD) spectrum.

Water decomposition oxygen production performance of Examples 1-5 was measured in an electrocatalytic water electrolysis oxygen evolution system.

In Examples 1, 2 and 3, the molar ratio of two metal cations was adjusted, and in Examples 1, 3 and 4, the molar ratio of the sulfur anion to the metal cations was adjusted.

### Example 1

1. A stainless steel substrate was cleaned ultrasonically with deionized water, acetone and ethanol in sequence for 10 min.
2. The ultrasonically cleaned stainless steel substrate in step 1 was heated and soaked in a dilute hydrochloric acid solution, where a concentration of diluted hydrochloric acid was 3 mol L⁻¹, acid soaking time was 4 h, and an acid soaking temperature was 60° C.
3. The stainless-steel substrate subjected to acid soaking in step 2 was washed and cleaned with deionized water, and then dried to obtain the stainless-steel substrate with a clean surface.
4. 1.5224 g of thiourea, 1.4540 g of nickel nitrate hexahydrate and 2.0200 g of iron nitrate nonahydrate were dissolved in 20 ml of deionized water and mixed well.
5. The solution prepared in step 4 was stirred for 80 min at a room temperature to be evenly mixed.
6. Then, the stainless-steel substrate with the clean surface obtained in step 3 was put into the solution of the step 5 after stirring for a heating reaction, where the reaction temperature was 90° C., and reaction time was 24 h.
7. An obtained sample after the reaction was finished in step 6 was washed with water, and then dried for 2 h at 60° C. to obtain the square-meter-scale stainless steel integrated electrode with a surface modified by bimetallic sulfide.

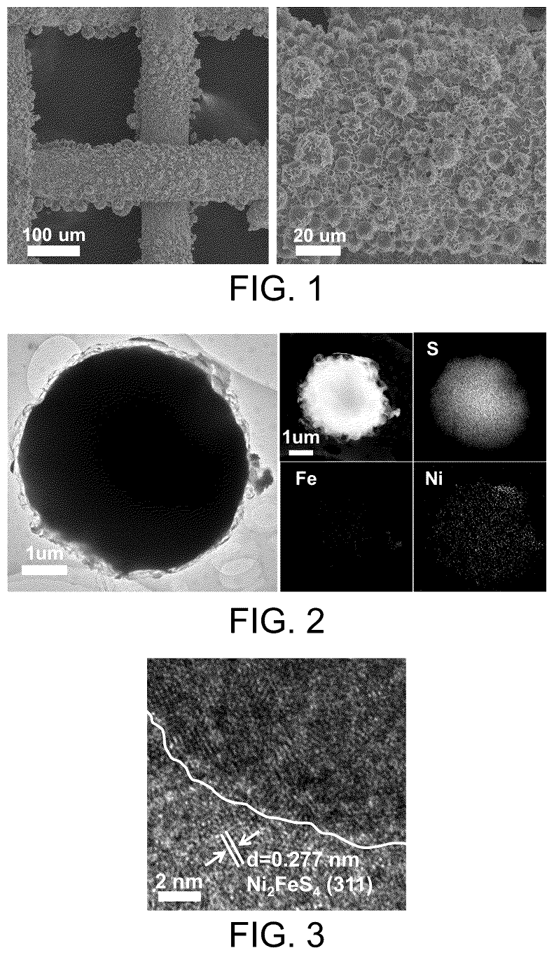

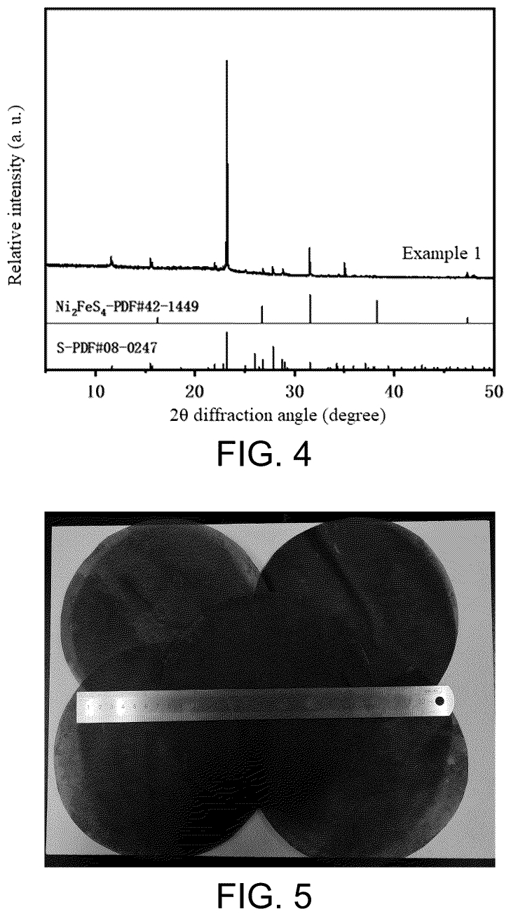

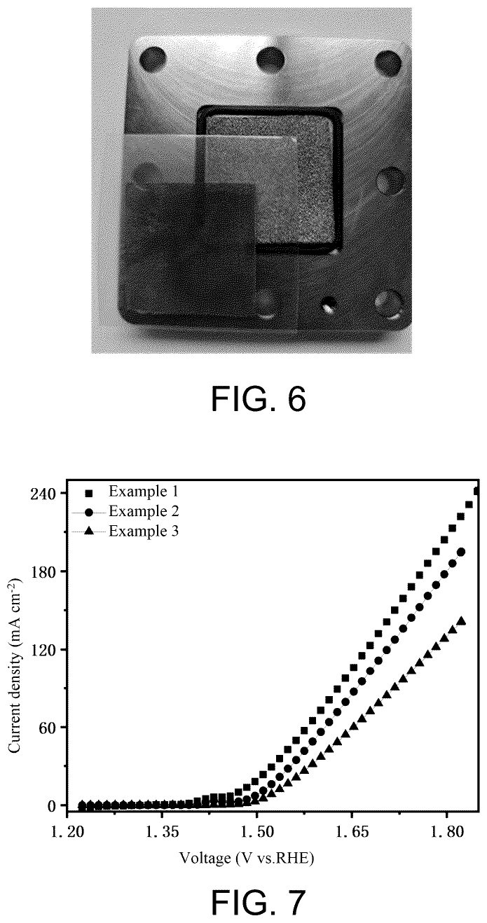

As shown in FIGS. 1 and 2, both the scanning electron microscopy and the transmission electron microscopy show that the prepared square-meter-scale stainless steel integrated electrode with a surface modified by bimetallic sulfide has a structure of a nanosphere wrapped in an ultrathin nanosheet, and the nanospheres wrapped in the ultrathin nanosheets are uniformly distributed on the surface of stainless steel. As shown in FIGS. 3 and 4, high-resolution transmission electron microscopy and the X-ray diffraction spectrum show that the ultrathin nanosheet is nickel sulfide and the nanosphere is elemental sulfur. As shown in FIGS. 5 and 6, the square-meter-scale stainless steel integrated electrode with a surface modified by bimetallic sulfide can be prepared in a large area. As shown in FIG. 9, the square-meter-scale stainless steel integrated electrode with a surface modified by bimetallic sulfide can achieve high stability in an electrocatalytic water decomposition oxygen evolution reaction.

### Example 2

1. A stainless steel substrate was cleaned ultrasonically with deionized water, acetone and ethanol in sequence for 10 min.
2. The ultrasonically cleaned stainless steel substrate in step 1 was heated and soaked in a dilute hydrochloric acid solution, where a concentration of diluted hydrochloric acid was 3 mol L⁻¹, acid soaking time was 4 h, and an acid soaking temperature was 60° C.
3. The stainless-steel substrate subjected to acid soaking in step 2 was washed and cleaned with deionized water, and then dried to obtain the stainless-steel substrate with a clean surface.
4. 1.5224 g of thiourea, 0.7270 g of nickel nitrate hexahydrate and 3.0299 g of iron nitrate nonahydrate were dissolved in 20 ml of deionized water and mixed well.
5. The solution prepared in step 4 was stirred for 80 min at a room temperature to be evenly mixed.
6. Then, the stainless-steel substrate with the clean surface obtained in step 3 was put into the solution of step 5 after stirring for a heating reaction, where the reaction temperature was 90° C., and reaction time was 24 h.
7. An obtained sample after the reaction was finished in step 6 was washed with water, and then dried for 2 h at 60° C. to obtain the square-meter-scale stainless steel integrated electrode with a surface modified by bimetallic sulfide.

### Example 3

1. A stainless steel substrate was cleaned ultrasonically with deionized water, acetone and ethanol in sequence for 10 min.
2. The ultrasonically cleaned stainless steel substrate in step 1 was heated and soaked in a dilute hydrochloric acid solution, where a concentration of diluted hydrochloric acid was 3 mol L⁻¹, acid soaking time was 4 h, and an acid soaking temperature was 60° C.
3. The stainless-steel substrate subjected to acid soaking in step 2 was washed and cleaned with deionized water, and then dried to obtain the stainless-steel substrate with a clean surface.
4. 1.5224 g of thiourea, 2.1809 g of nickel nitrate hexahydrate and 1.0099 g of iron nitrate nonahydrate were dissolved in 20 ml of deionized water and mixed well.
5. The solution prepared in step 4 was stirred for 80 min at a room temperature to be evenly mixed.
6. Then, the stainless-steel substrate with the clean surface obtained in step 3 was put into the solution of the step 5 after stirring for a heating reaction, where the reaction temperature was 90° C., and reaction time was 24 h.
7. An obtained sample after the reaction was finished in step 6 was washed with water, and then dried for 2 h at 60° C. to obtain the square-meter-scale stainless steel integrated electrode with a surface modified by bimetallic sulfide.

Discussion of results: in Examples 1-3, under the premise that other conditions are consistent (the ratio of thiourea to metal cations, the amount of water and an oven reaction at 90° C. for 24 h), the ratio of the two metal cations in the solution is adjusted by changing an additional amount of metal salts.

### Example 4

1. A stainless steel substrate was cleaned ultrasonically with deionized water, acetone and ethanol in sequence for 10 min.
2. The ultrasonically cleaned stainless steel substrate in step 1 was heated and soaked in a dilute hydrochloric acid solution, where a concentration of diluted hydrochloric acid was 3 mol L⁻¹, acid soaking time was 4 h, and an acid soaking temperature was 60° C.
3. The stainless-steel substrate subjected to acid soaking in step 2 was washed and cleaned with deionized water, and then dried to obtain the stainless-steel substrate with a clean surface.
4. 3.0448 g of thiourea, 5.8158 g of nickel nitrate hexahydrate and 8.0799 g of iron nitrate nonahydrate were dissolved in 20 ml of deionized water and mixed well.
5. The solution prepared in step 4 was stirred for 80 min at a room temperature to be evenly mixed.
6. Then, the stainless-steel substrate with the clean surface obtained in step 3 was put into the solution of step 5 after stirring for a heating reaction, where the reaction temperature was 90° C., and reaction time was 24 h.
7. An obtained sample after the reaction was finished in step 6 was washed with water, and then dried for 2 h at 60° C. to obtain the square-meter-scale stainless steel integrated electrode with a surface modified by bimetallic sulfide.

### Example 5

1. A stainless steel substrate was cleaned ultrasonically with deionized water, acetone and ethanol in sequence for 10 min.
2. The ultrasonically cleaned stainless steel substrate in step 1 was heated and soaked in a dilute hydrochloric acid solution, where a concentration of diluted hydrochloric acid was 3 mol L⁻¹, acid soaking time was 4 h, and an acid soaking temperature was 60° C.
3. The stainless-steel substrate subjected to acid soaking in step 2 was washed and cleaned with deionized water, and then dried to obtain the stainless steel substrate with a clean surface.
4. 3.0448 g of thiourea, 5.8158 g of nickel nitrate hexahydrate and 2.6933 g of iron nitrate nonahydrate were dissolved in 20 ml of deionized water and mixed well.
5. The solution prepared in step 4 was stirred for 80 min at a room temperature to be evenly mixed.
6. Then, the stainless-steel substrate with the clean surface obtained in step 3 was put into the solution of the step 5 after stirring for a heating reaction, where a reaction temperature was 90° C., and reaction time was 24 h.
7. An obtained sample after the reaction was finished in step 6 was washed with water, and then dried for 2 h at 60° C. to obtain the square-meter-scale stainless steel integrated electrode with a surface modified by bimetallic sulfide.

Discussion of results: in Examples 1, 4, 5, under the premise that other conditions are consistent (the ratio of the two metal cations, the amount of water and an oven reaction at 90° C. for 24 h), the ratio of sulfur to the metal cations in the solution is adjusted by changing addition amounts of the sulfur and metal salts.

### Application Example 1

The square-meter-scale stainless steel surface-modified integrated electrodes formed through bimetal sulfurization which were obtained in Examples 1-3 were used as integrated electrodes for an oxidation reaction of an electrocatalytic water decomposition oxygen production system, and the influence of the square-meter-scale stainless steel integrated electrode with a surface modified by bimetallic sulfide obtained by gradually changing the ratio of two metal cations in the solution on catalytic performance was investigated.
1. Test system setup: a test device was a three-electrode system, a reference electrode was Hg/HgO (1M KOH solution), a counter electrode was carbon rod, a working electrode was a 1*1 cm stainless steel integrated electrode with a surface modified by bimetallic sulfide, and electrolyte was 1M KOH solution.
2. Catalytic performance evaluation method: a temperature of an electrolytic cell was kept at 25° C., the capacity of a catalyst to oxidize hydroxyl anions (—OH) in the solution was tested through a polarization curve, and the potential required by the catalyst when a certain oxidation current density was achieved was compared.
3. The catalytic performance of the integrated electrode was changed by gradually changing the ratio of the two transition metal cations in the solution. As shown in FIG. 7, the stainless-steel surface-modified integrated electrode (S-1) formed through metal sulfurization of Example 1 has the optimal catalytic performance compared to Example 2 (S-2) and Example 3 (S-3). At the same current density (100 mA cm⁻²), overpotential of Example 1 (S-1) was 414 mV, overpotential of Example 2 (S-2) was 444 mV, and overpotential of Example 3 (S-3) was 508 mV. Therefore, the catalytic activity of the catalyst in the electrocatalytic water decomposition oxygen evolution reaction can be adjusted by changing the ratio of the two metal cations in the solution, so as to find the optimal ratio.

### Application Example 2

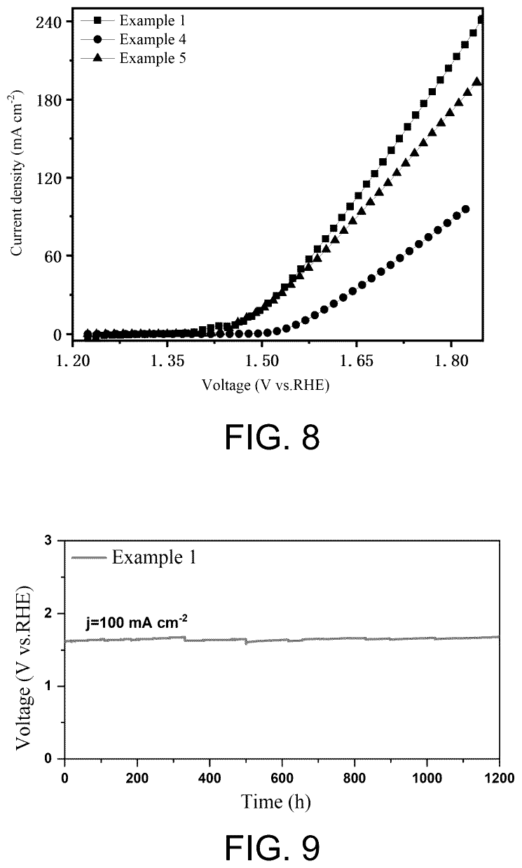

The square-meter-scale stainless steel surface-modified integrated electrodes formed through bimetal sulfurization which were obtained in Examples 1, 4 and 5 were used as integrated electrodes for an oxidation reaction of an electrocatalytic water decomposition oxygen production system, and the influence of the stainless steel integrated electrode with a surface modified by bimetallic sulfide obtained by gradually changing the ratio of sulfur and metal cations in the solution on catalytic performance was investigated.
1. Test system setup: a test device was a three-electrode system, a reference electrode was Hg/HgO (1M KOH solution), a counter electrode was carbon rod, a working electrode was a 1*1 cm stainless steel integrated electrode with a surface modified by bimetallic sulfide, and electrolyte was 1M KOH solution.
2. Catalytic performance evaluation method: the temperature of an electrolytic cell was kept at 25° C., the capacity of a catalyst to oxidize hydroxyl ions (OH) in the solution was tested through a polarization curve, and the potential required by the catalyst when a certain oxidation current density was achieved was compared.
3. The catalytic performance of the integrated electrode was changed by gradually changing the ratio of sulfur and transition metal cations in the solution. As shown in FIG. 8, the stainless-steel surface-modified integrated electrode (S-1) formed through metal sulfurization of Example 1 has the optimal catalytic performance compared to Example 4 (S-4) and Example 5 (S-5). At the same current density (100 mA cm⁻²), overpotential of Example 1 (S-1) was 414 mV, overpotential of Example 4 (S-4) was 593 mV, and overpotential of Example 5 (S-5) was 441 mV. Therefore, the catalytic activity of the catalyst in the electrocatalytic water decomposition oxygen evolution reaction can be adjusted by changing the ratio of sulfur and metal cations in the solution, so as to find the optimal ratio.

Finally, it should be noted that the above-mentioned examples are merely intended for describing the technical solutions of the present disclosure rather than limiting the present disclosure. Although the present disclosure is described in detail with reference to the above-mentioned examples, those of ordinary skill in the art should understand that they may still make modifications to the technical solutions described in the examples or equivalent substitutions to some or all the technical features of the technical solutions. These modifications or substitutions do not enable the corresponding technical solutions to depart from the scope of the technical solutions in all the examples of the present disclosure.

What is claimed is:

1. A square-meter-scale stainless steel integrated electrode with a surface modified by bimetallic sulfide, wherein the electrode has a structure of a nanosphere wrapped in an ultrathin nanosheet, the ultrathin nanosheet is nickel sulfide, the nanosphere is elemental sulfur, and materials of elemental sulfur nanospheres wrapped in ultrathin nickel sulfide nanosheets are uniformly distributed on a surface of stainless steel.

2. The square-meter-scale stainless steel integrated electrode with a surface modified by bimetallic sulfide according to claim 1, wherein the ultrathin nanosheet has a thickness of 5-50 nm, and the nanosphere has a diameter of 5-50 um.

3. The square-meter-scale stainless steel integrated electrode with a surface modified by bimetallic sulfide according to claim 1, wherein the integrated electrode is prepared by a one-step hydrothermal method.

4. A preparation method for the square-meter-scale stainless steel integrated electrode with a surface modified by bimetallic sulfide according to claim 1, comprising the following steps:
(1) performing ultrasonic cleaning on a stainless-steel substrate with deionized water, acetone and ethanol in sequence, performing heating and soaking with a dilute hydrochloric acid solution, and finally, performing drying after washing and cleaning with deionized water to obtain the stainless-steel substrate with a clean surface;
(2) dissolving two transition metal cation salts and a sulfur source in an aqueous solution and performing stirring at a room temperature for even mixing;
(3) putting the stainless-steel substrate with the clean surface obtained in the step (1) into the solution of the step (2) for a heating reaction, washing an obtained sample with water after the reaction is finished, and then, performing drying to obtain the square-meter-scale stainless steel integrated electrode with a surface modified by bimetallic sulfide.

5. The preparation method according to claim 4, wherein in the step (1), time of the ultrasonic cleaning is 5-20 min, a concentration of the dilute hydrochloric acid solution is 1-5 mol L-1, an acid soaking temperature is 50-80° C., and acid soaking time is 1-8 h.

6. The preparation method according to claim 4, wherein in the step (2), the transition metal cation salts are at least one of nitrate, sulfate, chloride, carbonate or acetate of transition metal cations, the transition metal cations are at least two of titanium, vanadium, chromium, manganese, iron, cobalt, nickel, copper, zinc or molybdenum, the sulfur source is at least one of thiourea, thioacetamide, sodium sulfide, thiophenol, thiol and thioether, in the solution, a molar ratio of sulfur anions to the transition metal cations is 1:5-5:1, and a molar ratio of the two transition metal cations is 1:4-4:1.

7. The preparation method according to claim 4, wherein in the step (2), time for stirring at the room temperature is 30-120 min.

8. The preparation method according to claim 4, wherein in the step (3), a reaction temperature is 60-100° C., reaction time is 12-24 h, a drying temperature is 30-100° C., and drying time is 1-6 h.

9. A method of using the square-meter-scale stainless steel integrated electrode with a surface modified by bimetallic sulfide according to claim 1 as an integrated electrode material in an electrocatalytic reaction.

10. The method according to claim 9, wherein the electrocatalytic reaction is a water electrolysis hydrogen evolution reaction.
